(19) United States
(12) Patent Application Publication
(10) Pub. No.: US 2005/0287677 A1
(43) Pub. Date: Dec. 29, 2005

(54) Dissolvent for volumetric analysis

(76) Inventors: Andreas Bosmann, Stegen (DE); Thomas Jurgen Siegfried Schubert, Freiburg (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/136,900

(22) Filed: May 25, 2005

(30) Foreign Application Priority Data
May 26, 2004 (DE) 10 2004 025 756.6

(51) Int. Cl. G01N 31/16

(52) U.S. Cl. 436/163

(57) ABSTRACT

The subject matter of the invention is to make available novel solvents for volumetric analysis of substances or compounds, such as, e.g., proteins, cellulose, etc., which are insoluble or difficult to dissolve in conventional solvents. In this way, a direct, homogeneous titration of components of these substances is enabled. For this purpose, in addition to the substances to be analyzed, the titration reagents can also be advantageously dissolved in an ionic liquid.

### BACKGROUND

For quantitative determination of substances in compounds, frequently a suitable form of titration is applied. Here, usually the compound to be analyzed is dissolved in a suitable solvent (test solution) and mixed with a specific reagent (titration solution) likewise dissolved in a suitable solvent. In special forms of titration, the reagent can also be generated, e.g., electrochemically, in the solution. The recognition of the end or neutral point of the titration can be realized in various ways, e.g., by a change in color of an indicator, electrochemically (by a change in potential on an electrode), thermometrically by a change in temperature, optically (by absorption of radiation), or by other suitable means.

Other preparations are realized using the example of Karl-Fischer titration (KF); however, it is clear to someone skilled in the art that the described problem, especially with regards to the solvent for the test substances, can be transferred freely to other titration methods.

The state of the art for the determination of water content by means of KF is the volumetric or coulometric titration of the water present in the sample with the help of so-called Karl-Fischer reagents. For this purpose, the sample can be dissolved in a suitable non-aqueous solvent and this solution can be titrated. Aside from with the water portion, if the components of the sample do not react with the titration system, then reliable measurement values are obtained in this way.

If no suitable solvent, which dissolves the sample homogeneously, can be found for certain samples, usually the suspension or emulsion of the sample in titrated in a solvent. This leads to changed kinetics of the titration reaction due to the necessary transition of water between phases. This impairs the recognition of the end point. In addition, deposits of the undissolved components on the electrodes of a coulometric cell can lead to non-reproducible results. As problem cases, for example, tests on cheese, cooking oils, and machine oils can be named.

Another method for testing hard-to-dissolve substances is the indirect determination of water content, in which the water contained in the sample is evaporated by heating and led into the measurement cell with a dry carrier gas flow and titrated there. Here, finding the temperature, at which the free water is stripped from the sample as much as possible, but without causing loss of water from the organic matrix, is problematic. This problem becomes especially clear in the testing of, e.g., biopolymers, which dissolve poorly in most solvents and for which water is lost from the molecule even at relatively low temperatures. In addition, this determination method also requires a comparatively high expense in terms of apparatus.

### SUMMARY

Ionic liquids have been known since the end of the 1940s. They concern molten salts, which are a liquid at room temperature and below and which present a novel class of solvents with non-molecular, ionic character. A common definition of ionic liquids in distinguishing them from known molten salts is a melting point below 80° C. Other references here name a melting point below room temperature. In this scope of this patent, ionic liquids are understood to be salts, which have a melting point below 80° C., preferably below room temperature, in the pure state.

Typical cation/anion combinations, which lead to ionic liquids, are, e.g., dialkylimidazolium, pyridinium, ammonium, and phosphonium with halogenide, tetrafluoroborate, methylsulfate. In addition, many other combinations of cations and anions are conceivable, which lead to such low-melting point salts.

In view of their use in technical processes, the basic properties of this material class are of interest:
good dissolving properties for many substances;
practically no vapor pressure (therefore no azeotropic formation);
non-combustible;
large liquid range from −60° C. to 400°.

Overviews on ionic liquids, their production, properties, and use can be found, e.g., in: “Ionic Liquids in Synthesis,” P. Wasserscheid, T. Welton (editors), Wiley; “Green Industrial Applications of Ionic Liquids” (NATO Science Series, Ii, Mathematics, Physics, and Chemistry, 92); “Ionic Liquids: Industrial Applications for Green Chemistry” (ACS Symposium Series, 818) by Robin D. Rogers (editor).

Ionic liquids can dissolve a wide range of substances homogeneously. The dissolving properties can be customized within a wide scope. Thus, cellulose, which is extremely difficult to dissolve, can be dissolved homogeneously without changing the chemical structure in a chloride-containing ionic fluid. Similar examples can be found from sectors of enzymatic analysis and biocatalysis, petrochemistry, and many others.

Particularly interesting is the property of ionic liquids to function simultaneously as a polar solvent and also as a homopolar solvent. In this way, within certain limits, polar and homopolar substances can be dissolved simultaneously. For example, it is possible to dissolve in the ionic liquid tetraalkylphosphoniumtosylate in addition to 10 mass % decant as a homopolar substance and also 5 mass % water as a polar substance. Another advantage of the ionic liquids is their great chemical stability. They can dissolve a large number of substances viewed as very reactive, without reacting with these substances. In this way, very reactive titration reagents (e.g., strong oxidants, such as H₂O₂) can also be dissolved in ionic liquids, without attacking the solvent itself.

Finally, through their immeasurable vapor pressure, ionic liquids offer the possibility of storing titration or sample solutions over longer periods of time, without causing changes in concentration due to evaporation of the solvent, e.g., in the storage containers of automatic titration systems. This can be important especially for applications, which take place at a permanently elevated ambient temperature.

In addition, the extremely low vapor pressure and the high thermal stability of the ionic liquids permits titration to be performed at an elevated temperature, without having to fear changes in concentration due to evaporation of the solvent. This can be advantageous in cases, in which, e.g., the reaction rate of a selected titration reaction is not sufficiently high and is to be increased by raising the temperature, e.g., in the saponification of fats with KOH. In other cases, elevated temperatures are advantageous in order to stop undesired reactions, for example, the polymerization of the indicator eriochrome black T at low pH values and high concentrations of alkali metals. Ionic fluids here present the possibility of opening up a significantly larger temperature range than with conventional solvents without building up pressure.

### BRIEF DESCRIPTION OF THE DRAWING

The use of ionic liquids as a solvent for titration can be realized in various ways:

In one embodiment, the otherwise difficult-to-dissolve sample substance is dissolved in an ionic liquid and titrated with a conventional titration solution. Here, the ionic liquid is advantageously miscible with the titration solution and the volume ratios are selected, so that after reaching the titration end point, a homogeneous solution is present, except for conditional precipitates produced by the type of titration.

In another embodiment, the sample solution is produced in a conventional solvent and the titration reagents are dissolved in an ionic liquid. This embodiment is preferred in the application of titration reagents that are more reactive or more difficult to dissolve, for which a conventional solvent is to be found only with difficulty. Here, a homogeneous mixture should also be present over the entire mixing range of sample and titration solutions.

In an especially preferred embodiment, both the sample solution and also the titration solution are produced with ionic liquids as the solvent, so that the ionic liquids used in both solutions are miscible with each other and total solubility of the sample substance and the titration reagents exists over the entire mixing range.

Other preparations are performed with the example of the Karl-Fischer titration; however, it is clear to someone skilled in the art that the described problems, especially with regards to the solvent for the sample substances, can be transferred freely to other titration methods.

For the common Karl-Fischer reagents, it is to be emphasized that all components have good solubility and are stable in ionic liquids. In this way, it is also possible to produce a titration solution based on ionic liquids as the solvent. These solutions produced in this way distinguish themselves in that for the typical storage of Karl-Fischer titration solutions in bottles with dry caps, there is no change in concentration due to evaporation of the solvent.

For sample substances viewed as problematic with regards to their solubility, in the ionic liquids suitable for these substances, freely soluble, inhomogeneous multi-component systems, such as, e.g., cheese or tar-like compounds can advantageously be dissolved homogeneously in ionic liquids. In particular, hydrophobic substances, such as machine oil and transformer oils are dissolved homogeneously by ionic liquids.

In the claims, the SMILES nomenclature (Simplified Molecular Input Line Entry System) is used for chemical formulas, see Weininger et al., Chem. Des. Autom. News 1986, 1, 2-15.

This is shown in the examples 1 and 2, as well as 3, which illustrate the invention, without limiting its scope.

Thus, ionic liquids are very well suited in view of their dissolving properties for preparing solvents for otherwise difficult-to-dissolve substances for the Karl-Fischer titration.

### DETAILED DESCRIPTION OF THE PREFERRED EMBODIMENTS

### Example 1

### Titration

In 20 ml of dry ionic liquid, trihexyltetradecylphosphonium-chloride, approximately 2 g of the butter oil is weighed in exactly and dissolved by stirring. This solution is titrated with the help of a titrino with the use of a hydranal composite 5 solution. The triple determination produces a water content of 852 ppm.

A titration according to ISO 5536 produces a water content of 848 ppm.

### Example 2

### Solubility Tests

As the solvent, EMIM-EtSO4 (ethylmethylimidaxolium-ethylsulfate) is used. In an amount of 10 mL EMIM-EtSO4, the following substances, which are difficult to dissolve in methanol, are dissolved:
Gummi bears 500 mg
Parmesan cheese 300 mg
Hazelnut 350 mg

None of these substances is soluble in methanol, which is typically used for sample preparation.

### Example 3

### Evaluation of the Hygroscopicity

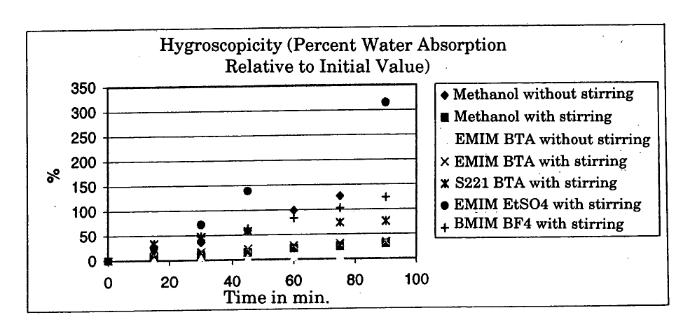

In a Thunder Scientific moisture generator, different ionic liquids are exposed to a relative air humidity of 45% at 25° C. For comparison, methanol, which is the solvent typically used for the Karl-Fischer titration, is exposed to these same conditions. The ionic liquids are stirred for better mixing. To determine the hygroscopicity, at intervals of approx. 15 minutes, samples were removed and the moisture content was determined by means of the Karl-Fischer titration. Table 1 shows the resulting measurement values (moisture in mass %). FIG. 1 shows the profile of the moisture absorption of the examined solvents.

TABLE 1
Determination of hygroscopicity

| t [min] | MeOH | EMIM-BTA | S221-BTA | EMIIM-EtSO4 |
|---|---|---|---|---|
| 0 | 0.02 | 0.01 | 0.01 | 0.01 |
| 15 | 0.28 | 0.11 | 0.20 | 0.31 |
| 30 | 0.66 | 0.20 | 0.28 | 0.86 |
| 45 | 1.07 | 0.26 | 0.35 | 1.67 |
| 60 | 1.78 | 0.34 | 0.41 | 2.02 |
| 75 | 2.30 | 0.38 | 0.45 | 3.15 |
| 90 | 2.80 | 0.41 | 0.46 | 3.78 |

Where:
EMIM-BTA is ethylmethylimidazolium-bis(trifluormethansulfone)imide
S221-BTA is diethylmethylsulfonium-bis(trifluormethanesulfone)imide
EMIM-EtSO4 is ethylmethylimidazolium ethylsulfate

This shows that the ionic liquids are comparable to methanol in terms of their hygroscopicity.

1. Method for volumetric determination of substances in pure substances or compounds comprising the steps: 1) producing a titration solution by dissolving a titration substance in a solvent, 2a) producing a sample solution by dissolving a sample in a solvent or 2b) producing a sample solution by dissolving the sample in a solvent and reaction with a known amount of reagents, 3a) adding the titration solution to the sample solution in a way that permits a quantitative determination of the introduced amount of titration solution up to an end point of the titration or 3b) adding the titration solution to the sample solution all at once or in steps and in situ generation of a reactive titration species through an electrochemical reaction monitored with coulometry up to the end point of the titration,
wherein
the solvents used in step 1) or in step 2) or in steps 1) and 2) are ionic liquids, which correspond to a general formula aA^{m+}bXⁿ⁻, wherein n=1 or n=2 and m=1 or m=2 and a*m=b*n
and cation A is selected from
quaternary ammonium cations having a general formula [R′″][N+]([R′])([R″])[R];
quaternary phosphonium cations having a general formula [R′″][P+]([R])([R″])[R];
imadazolium cations having a general formula [R]N1C═C[N+]([R′])═C1,
where the imidazolium can be substituted by at least one group, which is selected from
halogenides, hydroxyl, linear or branched, substituted or non-substituted alkyl radicals of up to 20 carbon atoms, which can be substituted with one or more groups selected from halogenides, hydroxyl, nitrile, amino, mercapto, and
radicals having a general formula —(R¹—Y)ₚ—R² with p=1-10, wherein R¹ is a linear or branched alkyl group with 1 to 20 carbon atoms, R² is hydrogen or a linear or branched alkyl group, and Y is an ether group, thioether group, ester group, siloxane group, or amide group;
morpholinium cations having a general formula [R][N+]1CC[O]CC1, where the morpholinium nucleus can be substituted by at least one group, which is selected from
halogenides, hydroxyl, linear or branched, substituted or non-substituted alkyl radicals up to 20 carbon atoms, which can be substituted with one or more groups selected from the halogenides, hydroxyl, nitrile, amino, mercapto, and
radicals having a general formula —(R¹—Y)ₚ—R² with p=1-10, wherein R¹ is a linear or branched alkyl group with 1 to 20 carbon atoms, R² is hydrogen or a linear or branched alkyl group and Y is an ether group, thioether group, ester group, siloxane group, or amide group;
oxazolinium cations having a general formula [R][N+]1=COCC1, wherein an oxazolinium nucleus can be substituted by at least one group, which is selected from halogenides, hydroxyl, linear or branched, substituted or non-substituted alkyl radicals up to 20 carbon atoms, which can be substituted with one or more groups selected from halogenides, hydroxyl, nitrile, amino, mercapto, and radicals having a general formula —(R¹—Y)ₚ—R² with p=1-10, wherein R¹ is a linear or branched alkyl group with 1 to 20 carbon atoms, R² is hydrogen or a linear or branched alkyl group and Y is an ether group, thioether group, ester group, siloxane group, or amide group;
pyridinium cations having a general formula [R][N+]1═CC═CC═C1, wherein a pyridinium nucleus can be substituted by at least one group selected from halogenides, hydroxyl, linear or branched, substituted or non-substituted alkyl radicals up to 20 carbon atoms, which can be substituted with one or more groups selected from halogenides, hydroxyl, nitrile, amino, mercapto, and
radicals having a general formula —(R¹—Y)ₚ—R² with p=1-10, wherein R¹ is a linear or branched alkyl group with 1 to 20 carbon atoms, R² is hydrogen or a linear or branched alkyl group, and Y is an ether group, thioether group, ester group, siloxane group, or amide group;
pyrrolidinium cations having a general formula [R][N+]1([R′])CCCC1, wherein a pyrrolidinium nucleus can be substituted by at least one group selected from halogenides, hydroxyl, linear or branched, substituted or non-substituted alkyl radicals up to 20 carbon atoms, which can be substituted with one or more groups selected from halogenides, hydroxyl, nitrile, amino, mercapto, and
radicals having a general formula —(R¹—Y)ₚ—R² with p=1-10, wherein R¹ is a linear or branched alkyl group with 1 to 20 carbon atoms, R² is hydrogen or a linear or branched alkyl group, and Y is an ether group, thioether group, ester group, siloxane group, or amide group;
pyrazolium cations having a general formula [R][N+]1C═CC═N1, wherein a pyrazolium nucleus can be substituted by at least one group selected from
halogenides, hydroxyl, linear or branched, substituted or non-substituted alkyl radicals up to 20 carbon atoms, which can be substituted with one or more groups selected from halogenides, hydroxyl, nitrile, amino, mercapto, and
radicals having a general formula —(R¹—Y)ₚ—R² with p=1-10, wherein R¹ is a linear or branched alkyl group with 1 to 20 carbon atoms, R² is hydrogen or a linear or branched alkyl group, and Y is an ether group, thioether group, ester group, siloxane group, or amide group;
triazolium cations having a general formula [R][N+]1([R′])N═CC═N1 or [R][N+]1([R′])C═NC═N1, wherein a triazolium nucleus can be substituted by at least one group selected from halogenides, hydroxyl, linear or branched, substituted or non-substituted alkyl radicals up to 20 carbon atoms, which can be substituted with one or more groups selected from halogenides, hydroxyl, nitrile, amino, mercapto, and
radicals having a general formula —(R¹—Y)ₚ—R² with p=1-10, wherein R¹ is a linear or branched alkyl group with 1 to 20 carbon atoms, R² is hydrogen or a linear or branched alkyl group, and Y is an ether group, thioether group, ester group, siloxane group, or amide group;
guanidinium cations having a general formula [R′]N([R])C(N([R″])[R″])═[N+]([R″])[R′″], wherein a guanidinium nucleus can be substituted by at least one group selected from
halogenides, hydroxyl, linear or branched, substituted or non-substituted alkyl radicals up to 20 carbon atoms, which can be substituted with one or more groups selected from halogenides, hydroxyl, nitrile, amino, mercapto, and
radicals having a general formula —(R¹—Y)ₚ—R² with p=1-10, wherein R¹ is a linear or branched alkyl group with 1 to 20 carbon atoms, R² is hydrogen or a linear or branched alkyl group, and Y is an ether group, thioether group, ester group, siloxane group, or amide group;
and in the general formulas, the radicals R, R′, R″, R′″ are selected independently of each other from
hydrogen;
halogenides, hydroxyl, linear or branched, substituted or non-substituted alkyl radicals up to 20 carbon atoms, which can be substituted with one or more groups selected from halogenides, hydroxyl, nitrile, amino, mercapto, and
radicals having a general formula —(R¹—Y)ₚ—R² with p=1-10, wherein R¹ is a linear or branched alkyl group with 1 to 20 carbon atoms, R² is hydrogen or a linear or branched alkyl group, and Y is an ether group, thioether group, ester group, siloxane group, or amide group;
and the anion X′ is selected from the group comprising
halogenides, tetrafluoroborate, R^{a}BF₃^{_{−}}, haxafluorophosphate, R^{a}R^{a}R^{b}PF₃^{_{−}}, phosphate, R^{a}R^{b}PO₄^{_{−}}, dicyanamide, carboxylate Rₐ—COO⁻, sulfonate R^{a}—SO₃⁻, benzolsulfonate, toluolsulfonate, organic sulfates R^{a}—O—SO₃^{_{−}}, bis(sulfon)imides R^{a}—SO₂—N′—SO₂—R^{b}, imides of the structure [R^{b}]S([N—]C([R^{a}])═O)(═O)═O, wherein R^{a} and R^{b} can be a linear or branched, aliphatic or alicyclic alkyl radical or a C5-C15 aryl radical, C5-C15 aryl C1-C6 alkyl radical, or C1-C6 alkyl C5-C15 aryl radical containing 1 to 20 carbon atoms independent of each other, which can be substituted by halogen atoms and/or hydroxyl groups.

2. Method for volumetric determination of substances in pure substances or compounds according to claim 1, wherein mixtures of two or more ionic liquids are used in one or both steps 1) and 2).

3. Method for volumetric determination of substances in pure substances or compounds according to claim 1, wherein the ionic liquids are used in a compound with one or more solvents selected from the group of water, alcohol, ether, alkanes, aromates, amines, amides, halogen alkanes, halogen aromates, dialkyl sulfoxide.

4. Method for volumetric determination of substances in pure substances or compounds according to claim 1, wherein a determination of water content according to the Karl-Fischer method is used.

5. Method for volumetric determination of substances in pure substances or compounds according to claim 1, wherein a determination with an end-point determination by means of an indicator is used.

6. Method for volumetric determination of substances in pure substances or compounds according to claim 1, wherein a determination with a potentiometric end-point determination is used.

7. Method for volumetric determination of substances in pure substances or compounds according to claim 1, wherein a determination with a photometric end-point determination is used.

8. Method for volumetric determination of substances in pure substances or compounds according to claim 1, wherein a determination with an end-point determination utilizing nuclear magnetic resonance spectroscopy is used.

9. Method for volumetric determination of substances in pure substances or compounds according to claim 1, wherein a determination with a thermometric end-point determination is used.

10. Method for volumetric determination of substances in pure substances or compounds according to claim 1, wherein a determination with a conductimetric end-point determination is used.

11. Method for volumetric determination of substances in pure substances or compounds according to claim 1, wherein the titration is performed manually.

12. Method for volumetric determination of substances in pure substances or compounds according to claim 1, wherein the titration is performed automatically.
